(19) United States
(12) Patent Application Publication
(10) Pub. No.: US 2015/0072706 A1
(43) Pub. Date: Mar. 12, 2015

(54) DETERMINING A MOBILITY STATE OF A USER EQUIPMENT

(71) Applicants: Per Henrik Michaelsen, Aalborg (DK); Simone Barbera, Aalborg (DK); Mikko Saily, Laukkoski (FI); Klaus Ingemann Pedersen, Aalborg (DK)

(72) Inventors: Per Henrik Michaelsen, Aalborg (DK); Simone Barbera, Aalborg (DK); Mikko Saily, Laukkoski (FI); Klaus Ingemann Pedersen, Aalborg (DK)

(73) Assignee: NOKIA SOLUTIONS AND NETWORKS OY, Espoo (FI)

(21) Appl. No.: 14/374,337

(22) PCT Filed: Jan. 30, 2012
(86) PCT No.: PCT/EP2012/051473

§ 371 Date: Aug. 22, 2014

(51) Int. Cl. G01S 11/06; H04W 4/02

(52) U.S. Cl. CPC G01S 11/06; H04W 4/027
USPC 455/456.1

(57) ABSTRACT

It is described a method for determining a mobility state of a user equipment within a cellular network system, the cellular network system comprising a plurality of cells. The method comprises performing, by the user equipment, measurements for a predefined time period for detecting cells being within a range of the user equipment, determining a number of cells being detected during the predefined time period, and determining the mobility state of the user equipment based on the number of cells, wherein the mobility state of the user equipment is indicative for a velocity of the user equipment relatively to the plurality of cells.

### FIELD OF INVENTION

The present invention relates to the field of cellular networks and in particular to heterogeneous networks.

### ART BACKGROUND

Cellular network systems may be arranged in multi-layer cellular systems—also referred to as heterogeneous networks (HetNet). In this context, multi-layer refers to cases with a mixture of macro base stations and small power base stations (for instance pico and micro). Macro-layer and pico/micro layer may also be implemented in different radio access technologies (RAT), for example GSM macro layer and LTE micro layer.

In cellular network systems, a degree of mobility of a user in a cellular network might be estimated, in particular when applying the Mobility State Estimation as defined by 3GPP (LTE) TS 36.304 (IDLE mode procedure based on cell reselections), and TS 36.331 (CONNECTED mode procedure based on performed handovers). According to these sections, a mobility state may be determined based on the number of mobility events (cell reselections when IDLE, or handovers when CONNECTED) which took place within a time window, as specified by T_{CRmax}. The mobility state may be used, inter alia, for scaling of cell reselection parameters.

The current procedures have been developed for regular cellular networks of large (macro) cells, where the main problem is that a fast moving user would often not perform cell reselection or handover fast enough. The solution is to select more aggressive mobility parameters (shorter Time To Trigger, and/or lower hysteresis), which would then also apply to users with low mobility, thus making their well performing mobility procedures too aggressive. The mobility state is used to scale the parameters such that the procedures become more aggressive only when the mobility is higher. The mobility state in this case is not a measure of the actual speed of movement, but rather a measure of the rate of mobility events per time.

The general problem is that currently estimated mobility state has an impact to the number of the future executed mobility events. That is, a used mobility state estimator has a feedback loop that takes the rate of mobility events as input to the estimator, which introduces a possibility of instability. Stability may be difficult to achieve with existing mobility state estimation method due to mobility parameter scaling, which in turn has an impact to the number of mobility events.

There may be a need for an improved system and method for determining a mobility state of a user equipment.

### SUMMARY OF THE INVENTION

This need may be met by the subject matter according to the independent claims. Advantageous embodiments of the present invention are described by the dependent claims.

According to a first aspect of the invention there is provided a method for determining a mobility state of a user equipment within a cellular network system, the cellular network system comprising a plurality of cells. The method comprises performing, by the user equipment, measurements for a predefined time period for detecting cells being within a range of the user equipment, determining a number of cells being detected during the predefined time period, and determining the mobility state of the user equipment based on the number of cells, wherein the mobility state of the user equipment is indicative for a velocity of the user equipment relatively to the plurality of cells.

This aspect of the invention is based on the idea to improve the determination of the mobility state of a user equipment by using discovered cells instead of a number of mobility events, like cell reselection or handovers.

The described method relates in particular to LTE rel. 11+ and in particular to HetNet measurements, but is not limited to these environments. The described method provides a way to enhance the

The herein described method refers to the estimation of the degree of mobility of a user equipment (UE) in a cellular network.

In LTE, the mobility state is defined or determined based on the number of mobility events (cell reselections when IDLE, or handovers when CONNECTED) which took place within a time window, as specified by T_{CRmax}.

For instance, as defined in TR 36.304, chapter 5.2.4.3, besides normal-mobility state, a high-mobility and a medium-mobility state are applicable if the parameters (TCRmax, NCR_H, NCR_M and TCRmaxHyst) are sent in the system information broadcast of the serving cell. Medium-mobility state criteria are detected if the number of cell reselections during the time period TCRmax exceeds NCR_M and not exceeds NCR_H. High-mobility state criteria are detected if the number of cell reselections during the time period TCRmax exceeds NCR_H. The UE shall not count consecutive reselections between same two cells into mobility state detection criteria if the same cell is reselected just after one other reselection. It is further defined that the UE shall, if the criteria for high-mobility state are detected, enter high-mobility state; else if the criteria for medium-mobility state are detected, enter medium-mobility state; else if criteria for either medium- or high-mobility state are not detected during time period TCRmaxHyst, enter normal-mobility state. If the UE is in high- or medium-mobility state, the UE shall apply the speed dependent scaling rules as defined in subclause 5.2.4.3.1.

In TS 36.331, chapter 5.5.6.2, it is described that the above described procedure is adapted for CONNECTED mode by counting handovers instead of reselections.

The current procedures have been developed for regular cellular networks of large (macro) cells, where the main problem is that a fast moving user would often not perform cell reselection or handover fast enough. The solution is to select more aggressive mobility parameters (shorter Time To Trigger, and/or lower hysteresis), which would then also apply to users with low mobility, thus making their well performing mobility procedures too aggressive. The mobility state is used to scale the parameters such that the procedures become more aggressive only when the mobility is higher. It should be noted that the mobility state is not a measure of the actual speed of movement, but rather a measure of the rate of mobility events per time.

In common systems based on the mobility state as defined above, the estimated mobility state has an impact to the number of the future executed mobility events. That is, a commonly used mobility state estimator has a feedback loop that takes the rate of mobility events as input to the estimator, which introduces a possibility of instability. Stability may be difficult to achieve with existing mobility state estimation method due to mobility parameter scaling, which in turn has an impact to the number of mobility events.

For example, considering a user moving, e.g. by car, through a network of macro and pico cells, which may have for example effective cell radii of 500 m and 100 m respectively. Assume that the user is moving at a speed that causes a number of handovers during the time window considered by the mobility state estimator that is above the threshold for being classified as high mobility. The mobility state is thus high.

Operators are experiencing handover failure problems in such cases due to frequent hand in and hand out of the small cells, and the same is observed in simulations. So some proposed features aim at restricting the access from high mobility users into small cells so that they are remaining as far as possible at the macro layer of larger cells.

Now consider the same user at the same speed moving along the same route, only initially having mobility state high, thus being prohibited access to the small cells. The number of handovers will then decrease by a factor, for instance in the described case approximately by a factor of 5 (500 m/100 m), which will likely cause the mobility state to drop to medium or even low. This means that a user moving at constant speed in a heterogeneous network will have a mobility state that tends to not stabilize, but rather go up and down in cycles, when features impacting mobility based on mobility state are introduced.

This may lead to the following issues. When applying scaling to mobility parameters to impact the aggressiveness of the mobility procedures, one also impacts the number of performed events (reselections or handovers), which means constitutes a positive feedback that may lead to an excessive reaction. A user that increases mobility, thus changes from normal to medium mobility state, may due to the resulting more aggressive mobility settings experience even more mobility events, resulting in a high mobility state.

Furthermore, the current Mobility State Estimation procedure only considers executed events (reselection/handover), which means that potential events that are not carried out due to access rules are not taken into account. Access rules in this context may refer for instance to CSG and not own cell, or blacklisted cell, i.e. potential target cell is on a list of non-accessible cells, or of non-accessible cell type, or handover is not performed due to network decision, e.g. for traffic (load), or any other access restriction reason. When potential events are not carried out, the measured rate of events will decrease, hence bias the Mobility State Estimation towards a too low state relative to the actual state of the user in terms of the mobility events that could have been executed if there were no restrictions. The latter is directly related to the movement of the user, where the former is also impacted by handover decision rules.

A handover commanded by the network, e.g. for traffic reasons, may on the other hand increase the measured rate of events in a way that is not determined by the movement of the user, hence biasing the Mobility State Estimation towards a too high state.

In 3GPP RAN WG2, it has been suggested to consider mechanisms for avoiding that users in high (or medium) mobility state perform handover (or reselection) towards small cells. Such mechanism, or any other that modifies the likelihood of a mobility event, may cause a bias on the rate of events.

The above mentioned issues have not been considered or addressed until now, since the Mobility State Estimation procedure as described in the art works quite well in regular networks of (larger) cells. However, problems may occur in heterogeneous networks with cells of unequal sizes.

The idea of the herein described method is to provide an improved and more stable measure of mobility by counting event opportunities, or cell discoveries, rather than just executed events. According to the described method, a possible target cell is counted, irrespective of the event being performed or not. This may eliminate the above mentioned issues.

The term “mobility state” in this context may refer to a velocity of a user equipment. It may refer in particular to a velocity relatively to the plurality of cells. In case, the user equipment is moving and is connected to a network which is also moving (for instance in a train or airplane), the velocity of the user equipment in relation to the cells will be low or zero.

The term “user equipment” in this context may be any type of communication end device, which is capable of performing the described measurements and determinations. The UE may be in particular a cellular mobile phone, a Personal Digital Assistant (PDA), a notebook computer, a printer and/or any other movable communication device.

The “plurality of cells” may be any kind of cell as being used in cellular network systems, in particular in heterogeneous networks. Each cell may be assigned to a base station. The term “base station” in this context may denote any kind of physical entity being able to hold one or more cells. A base station in this context may be any kind of network device providing the functionality for serving one or more cells; it may also be a transceiver node in communication with a centralized entity. The base station may be for example an eNodeB or eNB.

The “predefined time period” may be for instance a time period which is started at any point in time, when starting the determination of the mobility state. The time period may also be defined by two points in time (start time and end time).

According to an embodiment of the invention, performing measurements for detecting cells comprises at least one of a reference signal received power measurement and a reference signal received quality measurement.

The performed measurements may be measurements as being used in preparation of handover procedures. Instead of performing handovers based on these measurements, the user equipment may determine a number of cells being discovered or detected over the predefined time period.

According to a further embodiment of the invention, determining the mobility state of the user equipment comprises comparing the number of cells with a predefined threshold value.

The threshold value may be defined as a criterion for estimating the mobility state. The threshold value may be set or defined for instance during the network design. It may also be possible to define the threshold value based on actual network conditions.

According to a further embodiment of the invention, the mobility state of the user equipment is determined as high, medium, or normal.

The decision about the mobility state may be performed for instance according to the following:
If the number of cells is below a minimum value (NCR_M), the mobility state may be determined as normal.
If the number of cells is below a maximum value (NCR_H) and above a minimum value (NCR_M), the mobility state may be determined as medium.
If the number of cells is above a maximum value (NCR_H), the mobility state may be determined as high.

Also further mobility states or criteria may be used for determining the mobility state.

According to a further embodiment of the invention, determining a number of cells comprises increasing a counter value for each detected cell.

As one implementation, a counter may be used for counting the detected cells and determining the number of cells. The counter value may be set to zero at the beginning of the predefined time period.

According to a further embodiment of the invention, determining a number of cells comprises detecting whether one cell is detected more than one time, and adapting the counter value based on this detection.

The idea of this embodiment is based on the fact that it might be possible that a UE detects one and the same cell more than once. The UE should not count consecutive discoveries of the same cell into mobility state detection criteria if the discovery of the same cell is triggered multiple times during the predefined time period. A multiple counting of cells may lead to a distorted mobility state. The counter value may be for example decreased by one if it is detected that one cell has been counted twice.

According to a further embodiment of the invention, determining a number of cells comprises adding each detected cell to a table.

For determining the number of cells, a table may be used which comprises an entry for each detected cell. At the beginning of the determination, the table should be empty. During the measurements and detection cells, it may be determined whether one cell is already included in the table and in case of a multi-detection of the same cell no new entry will be added to the table.

According to a further embodiment of the invention, the method further comprises removing a cell from the table when, during performing measurements, the cell is not detected.

If the UE performs a new determination of the mobility state and uses for that the same table as before, an entry of a cell may be deleted or removed in case that this cell is not detected anymore.

According to a further embodiment of the invention, the plurality of cells are of different cell type characteristics, the cell type characteristics comprising at least one of cell type, cell coverage, cell capacity, cell size, cell weight, and cell priority.

This may refer in particular to the case of heterogeneous networks, comprising different cells. The term “cell type characteristics” may refer to cell characteristics or properties.

The cell type may be defined for instance by macro, micro, pico, femto. The cell coverage may define for instance a region (vertical or horizontal), in which a connection via the cell may be provided for a UE. The cell capacity may define the amount of communications (e.g., for multiple UEs, per UE) which may be supported. Cell capacity and cell coverage may also be combined under the term cell deployment. The cell size may define the size of a cell for instance via an enumerated value (e.g., large, medium, small, very small) or via a numerical absolute value (for instance diameter or perimeter, which may be specified in meter or centimeter). The different cells may also be weighted, for instance via a numerical relative value (e.g., 1.5, 1.0, 0.5, 0.25; i.e., the larger the weight, the higher the priority or vice versa). Such a weight may be specified for instance during the network design. The cell priority may refer to a priority cell status which may be assigned to some cells. This may denote that a cell with a higher priority may be preferred or prioritized over other cells. This may be independent of the size or other properties of the cells.

According to a second aspect of the invention, there is provided a user equipment for determining a mobility state of the user equipment within a cellular network system, the cellular network system comprising a plurality of cells. The user equipment comprises a measurement unit being adapted to perform measurements for a predefined time period for detecting cells being within a range of the user equipment, and a determination unit being adapted to determine a number of cells being detected during the predefined time period, and being adapted to determine the mobility state of the user equipment based on the number of cells, wherein the determined mobility state of the user equipment is indicative for a velocity of the user equipment relatively to the plurality of cells.

The user equipment (UE) may be any type of communication end device, which is capable of providing the described functionalities. The UE may be in particular a cellular mobile phone, a Personal Digital Assistant (PDA), a notebook computer, a printer and/or any other movable communication device.

The user equipment may comprise a receiving unit or receiver which is adapted for receiving signals from base stations serving the plurality of cells. The user equipment may comprise a transmitting unit for transmitting signals. The transmitting unit may be a transmitter as known by a skilled person. The receiver and the transmitting unit may be implemented as one single unit, for example as a transceiver. The transceiver or the receiver and the transmitting unit may be adapted to communicate with base stations of the plurality of cells via an antenna.

The user equipment may comprise a measurement unit and a determination unit as described above. The measurement unit and the determination unit of the user equipment may be implemented for example as part of a control unit, like a CPU or a microcontroller. The measurement unit and the transceiver may be coupled or may be implemented as one single unit. The measurement unit may be adapted to perform the measurements on signals received via the transceiver.

According to a third aspect of the invention, there is provided a base station being adapted to communicate with the user equipment having the above mentioned features.

The base station may be any type of access point or point of attachment, which is capable of providing a wireless access to a cellular network system. Thereby, the wireless access may be provided for a user equipment or for any other network element, which is capable of communicating in a wireless manner. The base station may be an eNodeB, eNB, home NodeB or HNB, or any other kind of access point. Each cell of the plurality of cells may be assigned to one base station, wherein one base station may also serve more than one cell.

The base station may comprise a receiving unit, for example a receiver as known by a skilled person. The base station may also comprise a transmitting or sending unit, for example a transmitter. The receiver and the transmitter may be implemented as one single unit, for example as a transceiver. The transceiver or the receiving unit and the sending unit may be adapted to communicate with the user equipment via an antenna.

The base station may also comprise a control unit for instance for controlling or scheduling handovers based on the determined mobility state. The control unit may be implemented as a single unit or may be implemented for example as part of a standard control unit, like a CPU or a microcontroller.

According to a fourth aspect of the invention, there is provided a cellular network system. The cellular network system comprises a user equipment as described above.

Generally herein, the method and embodiments of the method according to the first aspect may include performing one or more functions described with regard to the second, third or fourth aspect or an embodiment thereof. Vice versa, the user equipment, the base station or the cellular network system and embodiments thereof according to the second, third and fourth aspect may include units or devices for performing one or more functions described with regard to the first aspect or an embodiment thereof.

According to a fifth aspect of the herein disclosed subject-matter, a computer program for determining a mobility state of a user equipment is provided, the computer program being adapted for, when executed by a data processor assembly, controlling the method as set forth in the first aspect or an embodiment thereof.

As used herein, reference to a computer program is intended to be equivalent to a reference to a program element and/or a computer readable medium containing instructions for controlling a computer system to coordinate the performance of the above described method.

The computer program may be implemented as computer readable instruction code by use of any suitable programming language, such as, for example, JAVA, C++, and may be stored on a computer-readable medium (removable disk, volatile or nonvolatile memory, embedded memory/processor, etc.). The instruction code is operable to program a computer or any other programmable device to carry out the intended functions. The computer program may be available from a network, such as the World Wide Web, from which it may be downloaded.

The herein disclosed subject matter may be realized by means of a computer program respectively software. However, the herein disclosed subject matter may also be realized by means of one or more specific electronic circuits respectively hardware. Furthermore, the herein disclosed subject matter may also be realized in a hybrid form, i.e. in a combination of software modules and hardware modules.

In the above there have been described and in the following there will be described exemplary embodiments of the subject matter disclosed herein with reference to a cellular network system, a base station, a user equipment and a method of determining a mobility state of a user equipment. It has to be pointed out that of course any combination of features relating to different aspects of the herein disclosed subject matter is also possible. In particular, some embodiments have been described with reference to apparatus type embodiments whereas other embodiments have been described with reference to method type embodiments. However, a person skilled in the art will gather from the above and the following description that, unless otherwise notified, in addition to any combination of features belonging to one aspect also any combination between features relating to different aspects or embodiments, for example even between features of the apparatus type embodiments and features of the method type embodiments is considered to be disclosed with this application.

The aspects and embodiments defined above and further aspects and embodiments of the present invention are apparent from the examples to be described hereinafter and are explained with reference to the drawings, but to which the invention is not limited.

### BRIEF DESCRIPTION OF THE DRAWING

FIG. 1 shows a cellular network system according to an exemplary embodiment of the present invention.

FIG. 2 shows a user equipment and a base station within a cellular network system according to an exemplary embodiment of the invention.

It is noted that in different figures, similar or identical elements are provided with the same reference signs.

### DETAILED DESCRIPTION

In the following, embodiments of the herein disclosed subject matter are illustrated with reference to the drawings and reference to aspects of current standards, such as LTE. However, such reference to current standards is only exemplary and should not be considered as limiting the scope of the claims.

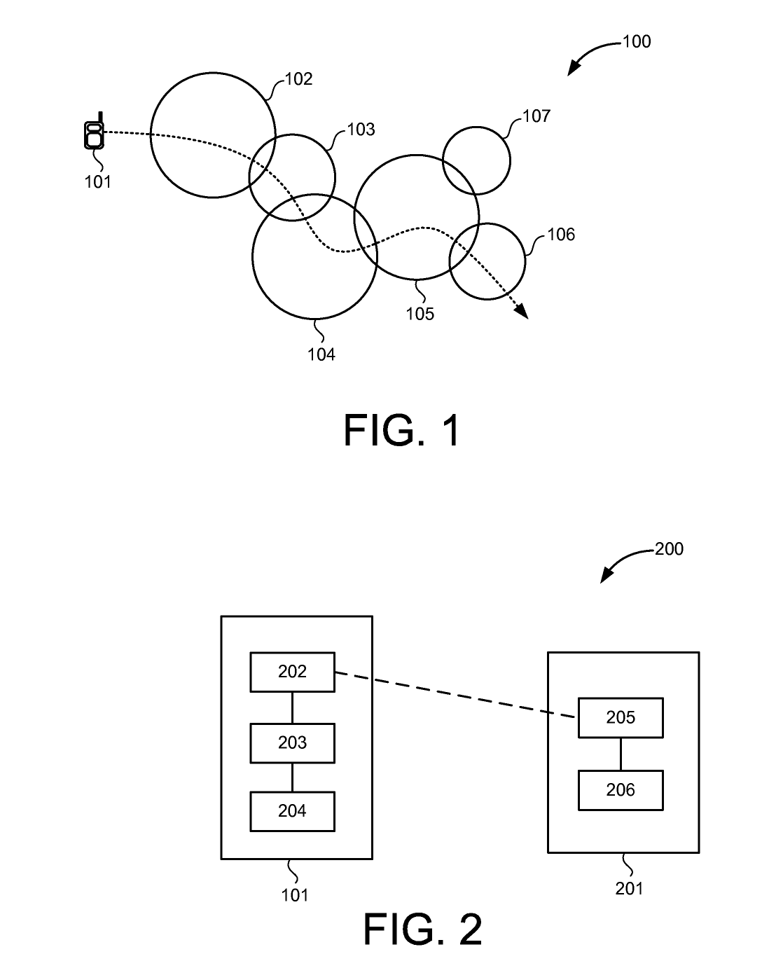

FIG. 1 shows a cellular network system 100. The cellular network system 100 comprises a plurality of cells 102-107. A user equipment 101, which moves through the network, may determine its mobility state according to the following method.

The user equipment 101 performs measurements for a predefined time period for detecting cells 102-106 being within a range of the user equipment 101. As may be seen in the exemplary network design of FIG. 1, the user equipment may eventually not detect cell 107 if this cell is not within the range of the user equipment. Subsequently, a number of cells being detected during the predefined time period will be determined. Based on this number of cells, the mobility state of the user equipment 101 will be determined. The mobility state of the user equipment is indicative for a velocity of the user equipment relatively to the plurality of cells 102-107.

According to the described method, a mobility state estimation algorithm is based on counts of discovered cells rather than on executed mobility events (reselections/handovers). The latter is used according to common systems and has the above mentioned disadvantages, i.e., for instance false increasing or decreasing of the mobility state.

The discovery of a cell may be assumed to be a decision based on a metric derived from measurements of signals from the cell being discovered. The procedure can be defined in such a way that multiple consecutive discoveries of the same cell due to variations in the considered measurement metric are excluded.

The problem of biased mobility state estimation is solved by considering the discovery of new cells, irrespective of actually performing a reselection (IDLE) or handover (CONNECTED) towards the cell as it is the case in common systems. The measured rate of cell discoveries is then independent on any rules or decisions related to the execution of potential mobility events, which means that the derived mobility state estimation is in this sense stable. The term “mobility state estimation” will be used throughout the document to be equivalent for the “method for determining a mobility state of the user equipment”.

In contrast to the current procedure, a cell discovery event may be used by the mobility state estimation procedure according to the herein described method by counting these events as opposed to executed mobility events (reselections in IDLE mode and handovers in CONNECTED mode). The cell discovery may be based for instance on the measurement of Reference Signal Received Power (RSRP) and/or Reference Signal Received Quality (RSRQ=RSRP/RSSI, where RSSI is the Received Signal Strength Indicator), or any other metric derived from these or similar cell specific measurements.

A possible implementation of the cell discovery decision procedure is similar to a handover event trigger that starts a timer when the considered metric fulfils certain requirements, and declares discovery when the metric has fulfilled certain, possibly different, requirements throughout a Time To Trigger (TTT) period of time. Any metric or procedure, such as the cell selection criterion (TR 36.304 5.2.3.2), event A1 (TR 36.331 5.5.4.2), or similar may be applicable as discovery decision algorithm.

In the following, a more specific example implementation will be described referring to a measurement, RXmeas, that may be assumed to be a decreasing function of the pathloss towards the cell being measured. If another measure is an increasing function of pathloss, one can simply multiply by −1 before applying the procedure as described. RXmeas(A) indicates a measurement on a particular cell that is named A.
1. Consider a UE (User Equipment) to be in one of two states relative to a cell A, either in-range of cell A, or out-of-range of cell A.
2. The UE may be considered to be in-range of any number of cells, and records these in a data structure, in the following called “set of in-range cells”.
3. The “set of in-range cells” is initially empty, i.e. a UE is initially considered to not be in-range of any cells.
4. The UE adds cell A to the “set of in-range cells”, when cell A is currently not in this set, and RXmeas(A)>MSERXHighThreshold (predefined maximum threshold for the pathloss).
   This action is considered a cell discovery to be counted for mobility state estimation.
5. The UE removes cell A from the “set of in-range cells”, when it is currently in the set, and RXmeas(A)<MSERXLowThreshold (predefined minimum threshold for the pathloss).

Concerning steps 4 and 5, a possible implementation can apply a hysteresis by applying different thresholds, such that MSERXHighThreshold=MSERXLowThreshold+hysteresis. A more extended implementation may perform the include/exclude from “set of in-range cells” only when the requirements on RXmeas(A) are fulfilled for a duration of time that is specified by a Time To Trigger parameter.

Concerning step 4, a possible implementation can add a further requirement to be fulfilled for this to be considered a cell discovery, in order to make it even less likely to declare multiple consecutive discoveries of the same cell. This may be in particular required, when applying neither hysteresis nor Time To Trigger window.

The suggested improvements to the mobility state estimation algorithm consists of counting the cell discoveries, as defined by the above step 4, as opposed to counting the executed mobility events, i.e. cell reselections, or handovers.

A medium-mobility state criteria is detected, if the number of cell discoveries during time period TCRmax exceeds a minimum threshold value (NCR_M) and not exceeds a maximum threshold value (NCR_H). A high-mobility state criteria is detected, if to number of cell discoveries during time period TCRmax exceeds a maximum threshold value NCR_H. The UE shall not count consecutive discoveries of the same cell into mobility state detection criteria if the discovery of the same cell is triggered multiple times during TCRmax.

It should be noted that the cell discovery event procedure may be applied in identical ways in IDLE and CONNECTED modes, only possibly with different RXmeas, or possibly with different parameters.

While other features for optimization of mobility performance, like in Self Optimizing Network (SON), are primarily considering cell based performance counters, the mobility state estimation may be used for user specific optimizations. It has proven difficult to achieve gains of cell based algorithms in mobility performance indicators due to differences among users, whereas it has proven feasible to achieve gains from the user specific optimization achieved by applying the mobility state estimation. The use case for the herein described algorithm is the further improvement of such features, while ensuring that the mobility state estimation is more stable and independent on mobility decisions introduced by the described features.

FIG. 2 shows a cellular network system 200 according to a further exemplary embodiment of the invention. The cellular network system comprises a base station 201 and a user equipment 101.

The user equipment may determine its mobility state within the cellular network system 200. The base station 201 may serve one or more cells of the cellular network system 200.

The user equipment 101 comprises a measurement unit 203 being adapted to perform measurements for a predefined time period for detecting cells being within a range of the user equipment, and a determination unit 204 being adapted to determine a number of cells being detected during the predefined time period, and being adapted to determine the mobility state of the user equipment based on the number of cells, wherein the determined mobility state of the user equipment is indicative for a velocity of the user equipment relatively to the plurality of cells.

The user equipment (UE) may be any type of communication end device, which is capable of providing the described functionalities. The UE may be in particular a cellular mobile phone, a Personal Digital Assistant (PDA), a notebook computer, a printer and/or any other movable communication device.

The user equipment may comprise a receiving unit or receiver which is adapted for receiving signals from base stations serving the plurality of cells. The user equipment may comprise a transmitting unit for transmitting signals. The transmitting unit may be a transmitter as known by a skilled person. The receiver and the transmitting unit may be implemented as one single unit, for example as a transceiver 202. The transceiver or the receiver and the transmitting unit may be adapted to communicate with base stations of the plurality of cells via an antenna, for instance with the base station 201 as shown in FIG. 2.

The measurement unit 203 and the determination unit 204 of the user equipment may be implemented for example as part of a control unit, like a CPU or a microcontroller. The measurement unit and the transceiver may be coupled or may be implemented as one single unit. The measurement unit may be adapted to perform the measurements on signals received via the transceiver, for instance from the base station 201.

The base station may be any type of access point or point of attachment, which is capable of providing a wireless access to a cellular network system. Thereby, the wireless access may be provided for a user equipment or for any other network element, which is capable of communicating in a wireless manner. The base station may be an eNodeB, eNB, home NodeB or HNB, or any other kind of access point. Each cell of the plurality of cells may be assigned to one base station, wherein one base station may also serve more than one cell.

The base station may comprise a receiving unit, for example a receiver as known by a skilled person. The base station may also comprise a transmitting or sending unit, for example a transmitter. The receiver and the transmitter may be implemented as one single unit, for example as a transceiver 205. The transceiver or the receiving unit and the sending unit may be adapted to communicate with the user equipment via an antenna.

The base station may also comprise a control unit 206 for instance for controlling or scheduling handovers based on the determined mobility state. The control unit may be implemented as a single unit or may be implemented for example as part of a standard control unit, like a CPU or a microcontroller.

Having regard to the subject matter disclosed herein, it should be mentioned that, although some embodiments refer to a “base station”, “eNB”, etc., it should be understood that each of these references is considered to implicitly disclose a respective reference to the general term “network component” or, in still other embodiments, to the term “network access node”. Also other terms which relate to specific standards or specific communication techniques are considered to implicitly disclose the respective general term with the desired functionality.

It should further be noted that a user equipment or base station as disclosed herein is not limited to dedicated entities as described in some embodiments. Rather, the herein disclosed subject matter may be implemented in various ways in various locations in the communication network while still providing the desired functionality.

According to embodiments of the invention, any suitable entity (e.g. components, units and devices) disclosed herein, e.g. the measurement unit, are at least in part provided in the form of respective computer programs which enable a processor device to provide the functionality of the respective entities as disclosed herein. According to other embodiments, any suitable entity disclosed herein may be provided in hardware. According to other—hybrid—embodiments, some entities may be provided in software while other entities are provided in hardware.

It should be noted that any entity disclosed herein (e.g. components, units and devices) are not limited to a dedicated entity as described in some embodiments. Rather, the herein disclosed subject matter may be implemented in various ways and with various granularities on device level while still providing the desired functionality. Further, it should be noted that according to embodiments a separate entity (e.g. a software module, a hardware module or a hybrid module) may be provided for each of the functions disclosed herein. According to other embodiments, an entity (e.g. a software module, a hardware module or a hybrid module (combined software/hardware module)) is configured for providing two or more functions as disclosed herein.

It should be noted that the term “comprising” does not exclude other elements or steps. It may also be possible in further refinements of the invention to combine features from different embodiments described herein above. It should also be noted that reference signs in the claims should not be construed as limiting the scope of the claims.

### LIST OF REFERENCE SIGNS

100 Cellular network system
101 User equipment
102 Cell
103 Cell
104 Cell
105 Cell
106 Cell
107 Cell
200 Cellular network system
201 Base station
202 Transceiver of user equipment
203 Measurement unit of user equipment
204 Determination unit of user equipment
205 Transceiver of base station
206 Control unit of base station

1. A method for determining a mobility state of a user equipment within a cellular network system, the cellular network system comprising a plurality of cells, the method comprising
performing, by the user equipment, measurements for a predefined time period for detecting cells being within a range of the user equipment,
determining a number of cells being detected during the predefined time period, and
determining the mobility state of the user equipment based on the number of cells, wherein the mobility state of the user equipment is indicative for a velocity of the user equipment relatively to the plurality of cells.

2. The method as set forth in claim 1, wherein performing measurements for detecting cells comprises at least one of a reference signal received power measurement and a reference signal received quality measurement.

3. The method as set forth in claim 1, wherein determining the mobility state of the user equipment comprises comparing the number of cells with a predefined threshold value.

4. The method as set forth in claim 1, wherein the mobility state of the user equipment is determined as high, medium, or normal.

5. The method as set forth in claim 1, wherein determining a number of cells comprises increasing a counter value for each detected cell.

6. The method as set forth in claim 5, wherein determining a number of cells comprises
detecting whether one cell is detected more than one time, and
adapting the counter value based on this detection.

7. The method as set forth in claim 1, wherein determining a number of cells comprises adding each detected cell to a table.

8. The method as set forth in claim 7, further comprising removing a cell from the table when, during performing measurements, the cell is not detected.

9. The method as set forth in claim 1, wherein the plurality of cells are of different cell type characteristics, the cell type characteristics comprising at least one of cell type, cell coverage, cell capacity, cell size, cell weight, and cell priority.

10. A user equipment for determining a mobility state of the user equipment within a cellular network system, the cellular network system comprising a plurality of cells, the user equipment comprising
a measurement unit being adapted to perform measurements for a predefined time period for detecting cells being within a range of the user equipment, and
a determination unit being adapted to determine a number of cells being detected during the predefined time period, and being adapted to determine the mobility state of the user equipment based on the number of cells, wherein the determined mobility state of the user equipment is indicative for a velocity of the user equipment relatively to the plurality of cells.

11-12. (canceled)

13. The user equipment as set forth in claim 10, wherein the measurement unit being adapted to perform measurements comprises the measurement unit being adapted to perform at least one of a reference signal received power measurement and a reference signal received quality measurement.

14. The user equipment as set forth in claim 10, wherein the determination unit being adapted to determine the mobility state of the user equipment comprises the determination unit being adapted to compare the number of cells with a predefined threshold value.

15. The user equipment as set forth in claim 10, wherein the mobility state of the user equipment is determined as high, medium, or normal.

16. The user equipment as set forth in claim 10, wherein the determination unit being adapted to determine a number of cells comprises the determination unit being adapted to increase a counter value for each detected cell.

17. The user equipment as set forth in claim 16, wherein the determination unit being adapted to determine a number of cells comprises the determination unit being adapted to
detect whether one cell is detected more than one time, and
adapt the counter value based on this detection.

18. The user equipment as set forth in claim 10, wherein the determination unit being adapted to determine a number of cells comprises the determination unit being adapted to add each detected cell to a table.

19. The user equipment as set forth in claim 18, wherein the user equipment is further adapted to remove a cell from the table when, during performing measurements, the cell is not detected.

20. The user equipment as set forth in claim 10, wherein the plurality of cells are of different cell type characteristics, the cell type characteristics comprising at least one of cell type, cell coverage, cell capacity, cell size, cell weight, and cell priority.
